(19) United States
(12) Patent Application Publication
(10) Pub. No.: US 2012/0191466 A1
(43) Pub. Date: Jul. 26, 2012

(54) Systems and Methods of Pharmaceutical Information Management

(76) Inventors: Saul QUINT, Thornhill (CA); David ALTER, Thornhill (CA); Cynthia JACKEVICIUS, Port Colborne (CA)

(21) Appl. No.: 13/013,548

(22) Filed: Jan. 25, 2011

(51) Int. Cl. G06Q 50/00

(52) U.S. Cl. 705/2

(57) ABSTRACT

A system for administering a mentoring program to a user comprising a user interface having a health risk assessment for providing a health risk assessment questionnaire to the user and a processor in communication with the user interface for generating alerts based on the received responses, The system generating risk scores associated with the user, then generating a report that is based on the alerts and/or the risk scores, and providing a notification to a health care practitioner once the report has been generated. The system further provides communications between the user interface and a health care practitioner interface to generate and communicate notifications associated with a mentoring program between the user and the health care practitioner.

### FIELD OF INVENTION

The present invention relates to health care management and more specifically relates to mentoring programs, including lifestyle mentoring programs for individuals.

### BACKGROUND

In a health care system there includes a plurality of health care providers including pharmacists, physicians, counselors, dieticians, employee assistance program providers, certified diabetes educators, and lifestyle coaches/mentors. Patients, or users of the health care system typically associate themselves with one or more health care provider; however, each health care provider typically has their own information systems that operate in isolation of the information systems of other health care providers. These separate information systems mean that certain information that may be helpful to one health care provider may not be available to that health care provider if it is on a different health care provider's information system.

Due to failings of current system, certain risk factors associated with a user may not be known by a health care provider and without this knowledge, the quality of health care provided to the user may compromised. It can be important to coordinate the health care delivered to a patient, especially in situations where some of the health care efforts must be self directed or self administered by the patient.

For example, certain patients may be at high risk with respect to taking their medications. For example, a patient may have a history of forgetting to take medications, or the patient may have a history of stopping taking their medications without direction from a health care provider. If health care providers are unaware of this, then the care they are providing for a patient may be compromised by the patient's own actions and without their knowledge.

In addition, patients may be at high risk for acquiring certain health problems, such as diabetes, hypertension, or other such health problems. While a patient may not currently have such problems, factors such as obesity and a high levels of stress can be contributors to these problems. In a patient's health care network, certain health care professionals may be aware of some or all of these risk factors, while others may not. For example, the a counselor or therapist may be aware of high stress levels of a particular patient with respect to their job that may represent a risk factor for a patient to develop hypertension; however, the patient's physician may be unaware of this risk factor and may not properly educate the patient with preventative measures or lifestyle changes.

In another example, a physician may be aware that a patient has, on occasion, stopped or forgotten to take their medication; however, may not inform other members of the patient's health care network, such as their pharmacist, of this patient's history of not following a medication regimen. A pharmacist, who may have more face-to-face time with a patient, or opportunity to speak with the patient personally, on a regular basis can mentor the patient with respect to medication administration regimens, but only if they are made aware of the patient's history.

Systems that provide health care management by providing for the administration of mentoring and/or lifestyle management programs can be helpful to aid in the provision of coordinated health care to a patient. For example, such systems can identify potential risk factors related to medication and alert the appropriate health care provider. By way of example, if a pharmacist is aware that a patient is at risk for missing, forgetting or refusing to take medication, the pharmacist can take a more active roll in the patient's health care, providing active mentoring to the patient to educate and inform the patient of the benefits of taking their medication, and actively monitoring the patient by checking in with them personally regarding their current medication taking habits.

Some patient management systems are coordinated with an individual's third party insurance provider, reviewing paid and unpaid claims made by an individual, and using that data to assess the individual's health risk. These systems can be deficient as the analysis is not provided in real-time, or near real-time, but instead utilizes historical data and relies on the patient submitting a claim to their third party insurance provider on a timely basis. The submission of a claim may occur months after a medication (for example) was started, and even after the medication has finished its course with the patient, if at all.

Additionally, these systems may not solicit information directly from the patient to assess certain risk factors, such as medication taking habits, stress levels, eating habits and nutritional behaviors, etc. Existing systems, for example, often assume that medication is being taken properly without obtaining information directly from the patient.

Further, these systems may not solicit information from all health care professionals in a patient's health care network, and may not communicate directly with all health care professionals, when appropriate, to provide a coordinated effort in mentoring and/or providing a lifestyle management program to a patient.

There is a need for patient mentoring and/or lifestyle management systems that provide coordinated health care to a patient, where the health care professionals associated with the patient are informed of the patient's health risks and the coordinated health care effort, and where such systems rely on current information with respect to the patient, coming directly from the patient and their health care providers.

### SUMMARY OF THE INVENTION

In an aspect of the present invention a system for administering a mentoring program to a user is provided, the system comprising: a user interface module operating on a processor for transmitting and receiving communications with a user workstation operated by the user, the user interface module having a health risk assessment module operating thereon, the health risk assessment module providing a health risk assessment questionnaire to the user, and for receiving an assessment response from the user; the processor having an alerts module operating thereon to process the received assessment response, and based thereon, generate an alert based on the received response; the processor further having a risk score assessment module operating thereon to generate a risk score associated with the user based on at least one of the generated alert and the received assessment response; and the processor further having a report generation module operating thereon to generate a report based on at least one of the generated alert and the generated risk score associated with the user; and a health care practitioner interface module operating on the processor for transmitting and receiving communications with a health care workstation operated by a health care practitioner associated with the user, the health care practitioner interface module having a health care notification module operating thereon for notifying the health care practitioner that at least one of the alert and the report has been generated upon the generation of the at least one of the alert and the report, the at least one of the alert and the report viewable by the health care practitioner on the health care workstation, wherein a health care notification associated with a mentoring program is generated and provided to the user for the user's review after the at least one of the alert and the report has been viewed by the health care practitioner; and a notification response is generated after the user's review of the health care notification and provided to the health care practitioner.

In some embodiments, the risk score generated by the risk score assessment module can include a medication risk score. In some embodiments, the health care interface module can enroll the user in a lifestyle mentoring program and can associate the user with a lifestyle mentor.

In some embodiments, the system can further comprise: a lifestyle health risk assessment module operating on the processor which can administer a lifestyle risk assessment questionnaire to the user through the user interface module and can receive a lifestyle response from the user; a lifestyle alerts module operating on the processor which can analyze the lifestyle response and can generate a lifestyle alert to send to a lifestyle mentor associated with the user, wherein the risk score assessment module can further update the risk score associated with the user based on at least one of the lifestyle alert and the lifestyle response provided by the user; the report generation module can generate a lifestyle report based on at least one of the lifestyle alert, the alert and the risk score associated with the user; the lifestyle mentor interface module can have a lifestyle mentoring program module operating thereon which can notify the lifestyle mentor that at least one of the lifestyle alert and the lifestyle report has been generated upon the generation of the at least one of the lifestyle alert and the lifestyle report, the at least one of the lifestyle alert and the lifestyle report can be viewable by the lifestyle mentor; wherein the lifestyle mentoring program module can generate a lifestyle notification associated with a lifestyle mentoring program for sending to at least one of the health care practitioner interface and the user interface after the at least one of the lifestyle alert and the lifestyle report has been viewed by the lifestyle mentor interface; and a lifestyle notification response can be generated from at least one of the user and the health care practitioner, based on a review of the lifestyle notification and provided to the lifestyle mentor.

In some embodiments, the lifestyle mentoring program can be at least one of a weight loss program, a stress management program, a nutrition program, an exercise training program, a diabetes management program, and a smoking or tobacco cessation program. In some embodiments, the system can further comprise a log file operating on the processor capable of documenting notifications and responses, the log file can be accessible by the user interface module, the health care interface module and the lifestyle mentoring program module.

In some embodiments, the alert can be at least one of a cardiovascular risk alert, a body mass index alert, a stress risk alert, a hypertension alert, a cholesterol level alert, a diabetic alert, a depression alert, a cancer alert, a high risk pregnancy alert, an asthma alert, a chronic obstructive pulmonary disease alert, and a medication risk alert.

In some embodiments, the health risk assessment questionnaire can include questions related to at least one of lifestyle factors, user-risk factors, diseases, behavioral readiness to change, work related productivity, biometrics, and medication related issues. In some embodiments the system can further comprise a user priority module which can operate on the processor and can be capable of triaging alerts generated by alerts module and can prioritize alerts provided to the health care practitioner in the report generated by the report generation module.

In a further aspect of the present invention a computer readable medium having instructions thereon for causing a processor to execute the instructions is provided, the instructions adapted to be executed to implement a method for administering a mentoring program to a user, the method comprising: providing a health risk assessment questionnaire to the user; receiving a response to the health risk assessment from the user; generating an alert based on the received response; generating a risk score associated with the user based on the at least one of the generated alert and the received assessment response from the user; generating a report based on at least one of the generated alert and the generated risk score associated with the user; notifying a health care practitioner associated with the user that at least one of the alert and the report has been generated upon the generation of the at least one of the alert and the report; generating a health care notification associated with a mentoring program after the at least one of the alert and the report has been viewed by the health care practitioner; sending the notification to the user; and accepting a notification response from the user based on the user's review of the health care notification.

In some embodiments, the risk score generated can include a medication risk score. In some embodiments, the method implemented by the processor of the computer readable medium can enroll the user in a lifestyle management program and can associate the user with a lifestyle mentor.

In some embodiments, the method implemented by the processor of the computer readable medium can further comprise: providing a lifestyle risk assessment questionnaire to the user; receiving a lifestyle response from the user; generating a lifestyle alert based on the received response; updating the risk score associated with the user based on at least one of the lifestyle alert and the lifestyle response provided by the user; generating a lifestyle report based on at least one of the lifestyle alert, the alert and the risk score associated with the user; notifying a lifestyle mentor that at least one of the lifestyle alert and the lifestyle report has been generated upon the generation of the at least one of the lifestyle alert and the lifestyle report; generating a lifestyle notification associated with a lifestyle mentoring program after the at least one of the lifestyle alert and lifestyle report has been viewed by the lifestyle mentor; sending the lifestyle notification to at least one of the health care practitioner and the user; and accepting at least one lifestyle notification response from at least one of the health care practitioner and the user, based on their review of the lifestyle notification.

In some embodiments, lifestyle mentoring program can be at least one of a weight loss program, a stress management program, a nutrition program, an exercise training program, a diabetes management program, and a smoking or tobacco cessation program.

In some embodiments, the method implemented by the processor of the computer readable medium can further comprise documenting notifications and responses in a log file, the log file can be accessible by the user, the health care practitioner and the lifestyle mentor.

In some embodiments, the alert can be at least one of a cardiovascular risk alert, a body mass index alert, a stress risk alert, a hypertension alert, a cholesterol level alert, a diabetic alert, a depression alert, a cancer alert, a high risk pregnancy alert, an asthma alert, a chronic obstructive pulmonary disease alert, and a medication risk alert; however skilled persons will understand that other health risk related alerts may be generated by the health risk assessment responses.

In some embodiments, the health risk assessment questionnaire can include questions related to at least one of lifestyle factors, user-risk factors, diseases, behavioral readiness to change, work related productivity, biometrics, and medication related issues. In some embodiments, the method implemented by the processor of the computer readable medium can further comprise triaging the alerts and prioritizing the alerts provided to the health care practitioner.

In a further aspect of the present invention, systems and methods are provided for screening, identifying and providing interventions for users who may be receiving medications with specific drug-related safety concerns, such as drug-drug interactions, drug-food interactions, drug-herbal and drug-over-the-counter (OTC) product interactions.

In a further aspect of the present invention, systems and methods are provided for screening, identifying and providing interventions for users who may be at risk of suboptimal compliance medication-taking behaviors, for example, due to dosing regimens, the number of medications, new medications, medication-switches, and self reported non-adherence.

In a further aspect of the present invention, systems and methods are provided for screening, identifying and providing interventions for users who may have disease or risk-factors for disease, who may not be currently taking medications, but for whom medication management supported by best-evidence may be appropriate.

In a further aspect of the present invention, systems and methods are provided for generating user, physician, employer sponsor and pharmacy reports that may notify each stakeholder of relevant medication related concerns where appropriate. Each concern may be documented and described differently to users, for example, to enhance the understanding and implications of the findings.

In a further aspect of the present invention, systems and methods are provided for the integration and interactions between, for example, pharmacists and lifestyle or disease-management health coaches in situations, for example, when additional medication issues and/or lifestyle disease-issues arise following a health screening assessment, or during the course of an intervention, so that new medication safety and behavioral problems may be appropriately addressed, when relevant.

In a further aspect of the present invention, systems and methods are provided for the delivery of educational materials (for example, educational articles, quick-tips) that pharmacists and/or other health care providers may utilize when assisting users through medication related issues.

In a further aspect of the present invention, systems and methods are provided to allow lifestyle management and pharmacy management programs to be purchased or provided through the use of coupons that integrate with an online shopping cart that allows a user to purchase a coupon to have the systems and methods described herein to be delivered to the user.

### BRIEF DESCRIPTION OF THE DRAWINGS

For a better understanding of embodiments of the system and methods described herein, and to show more clearly how they may be carried into effect, reference will be made by way of example, to the accompanying drawings in which:

FIG. 1 shows and embodiment of the a system for administering a mentoring program to a user;

FIG. 2 shows an embodiment of the pharmaceutical module of the system shown in FIG. 1 for administering a mentoring program to a user;

FIG. 3 shows an embodiment of questions provided to a user from a modified Morisky scale;

FIG. 4 shows an embodiment of a user interface for administering a health risk assessment;

FIG. 5 shows an embodiment of a user interface for providing medication information of a user for administering a health risk assessment;

FIG. 6 shows an embodiment of a user interface for administering a health risk assessment;

FIG. 7 shows an embodiment of a user interface for administering a health risk assessment;

FIG. 8 shows an embodiment of a user interface for providing medication behaviors of a user;

FIG. 9 shows an embodiment of a medication taking risk report;

FIG. 10 shows an embodiment of an alert report;

FIGS. 11 and 12 show an embodiment of pharmacist notifications;

FIG. 13 shows an embodiment of a user interface for selecting materials to attach to a notification;

FIG. 14 shows an embodiment of a lifestyle alert report;

FIG. 15 shows an embodiment of a documentation template for use by a health care practitioner to document action items;

FIG. 16 shows an embodiment of a process flow chart for generating alerts and reports based on a user's health risk assessment responses and for health care practitioner mentoring;

FIG. 17 shows an embodiment of a process flow chart for lifestyle coaching; and

FIG. 18 shows an embodiment of an email notification to a pharmacist.

### DETAILED DESCRIPTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. In an embodiment these systems and methods are implemented in computer programs executing on programmable computers each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, or cellular telephone. Program code is applied to input data to perform the functions described herein and generate output information. The output information is applied to one or more output devices, in known fashion.

Each program can be implemented in a high level procedural or object oriented programming and/or scripting language to communicate with a computer system. However, the programs can be implemented in assembly or machine language, if desired. In any case, the language may be a compiled or interpreted language. Each such computer program can be stored on a storage media or a device (e.g. ROM or magnetic diskette) readable by a general or special purpose programmable computer, for configuring and operating the computer when the storage media or device is read by the computer to perform the procedures described herein. The embodiments may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

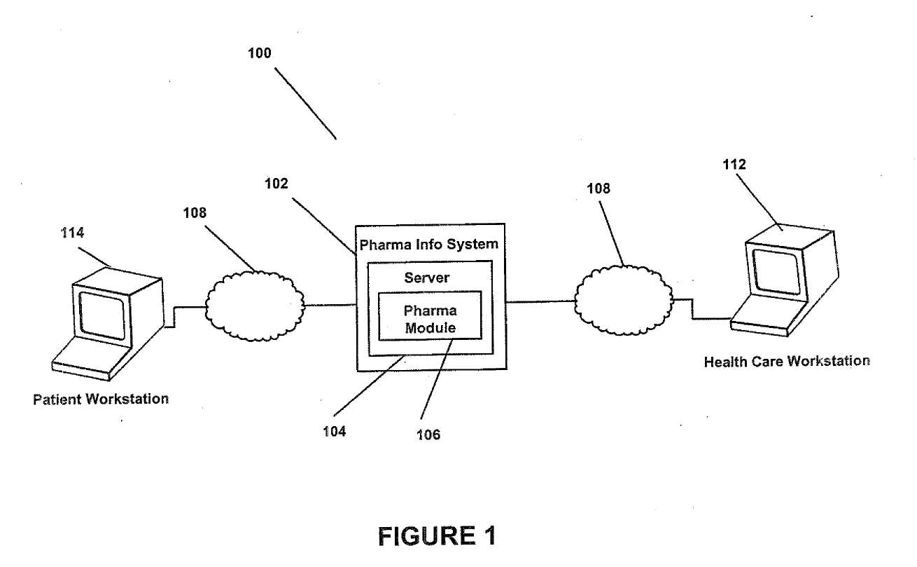

Referring to FIG. 1, system 100 is shown. System 100 includes pharmaceutical information system 102 which has server 104, the server having programming and hardware to execute pharmaceutical module 106. Pharmaceutical module 106 can be implemented in hardware or software and is administering a mentoring program to a user.

A health care provider, such as a pharmacist, physician, lifestyle coach/mentor, counselor, dietician, employee assistance program provider, certified diabetes educator, or any other health care provider associated with the user, can access pharmaceutical module 106 through health care workstation 112, through network 108, for example by logging into pharmaceutical module 106 using a unique ID and logon password. The embodiments and examples described herein will refer to a pharmacist, however, skilled persons will understand that the systems and methods described herein can include any health care provider, and may include more than one health care provider. Skilled persons will additionally understand that reports, alerts, notifications, graphical displays, and the like, described herein can be customized for a specific health care provider, for example in embodiments where a dietician is a health care provider associated with an identifiable user, the dietician can received customized reports, alerts and the like, that are in relation to the identifiable user's diet. Thus, while the embodiments described herein use the example of a pharmacist and describe examples of information, alerts and reports that are customized to a pharmacist, skilled persons will appreciate that other health care providers can be added to the systems and methods (or can replace a pharmacist in the systems and methods described) and information, alerts and reports can be customized for that particular health care provider.

User workstation 114 and health care workstation 112 are connected to pharmaceutical information system 102 by network connection 108, which can be a local area network, wide area network, wireless network, the Internet, or other similar communication network capable of providing a communication means between user workstation 114 and health care workstation 112 via pharmaceutical information system 102.

Pharmaceutical module 106 includes health risk assessment module 202 capable of accessing questions stored in health risk assessment questionnaire 204 and is capable of administering a health risk assessment to a user. Questions stored in health risk assessment questionnaire 204 are related to lifestyle factors, risk-factors, diseases, behavioral readiness-to-change, work-related productivity, biometrics of the user, and medication-related issues, however, skilled persons will understand that health risk assessment questionnaire 204 can include other questions related to the health and life-style of the user for determining user risk factors. Health risk assessment module 202 administers a health risk assessment to a user and stores responses in health risk assessment response database 206.

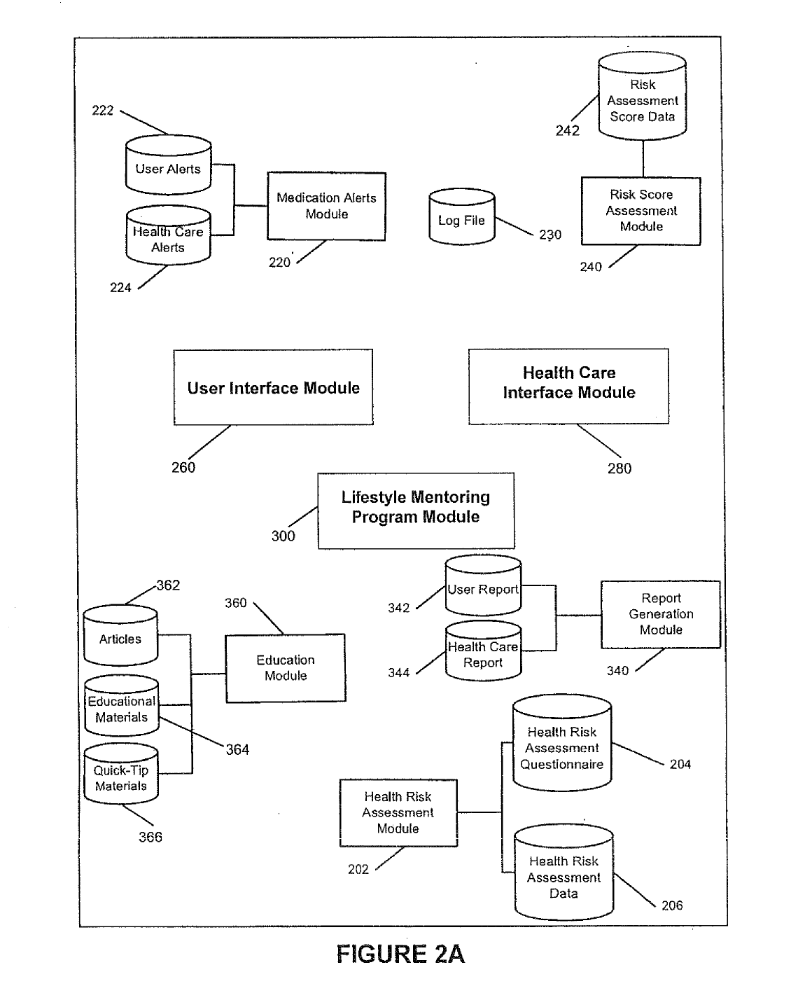

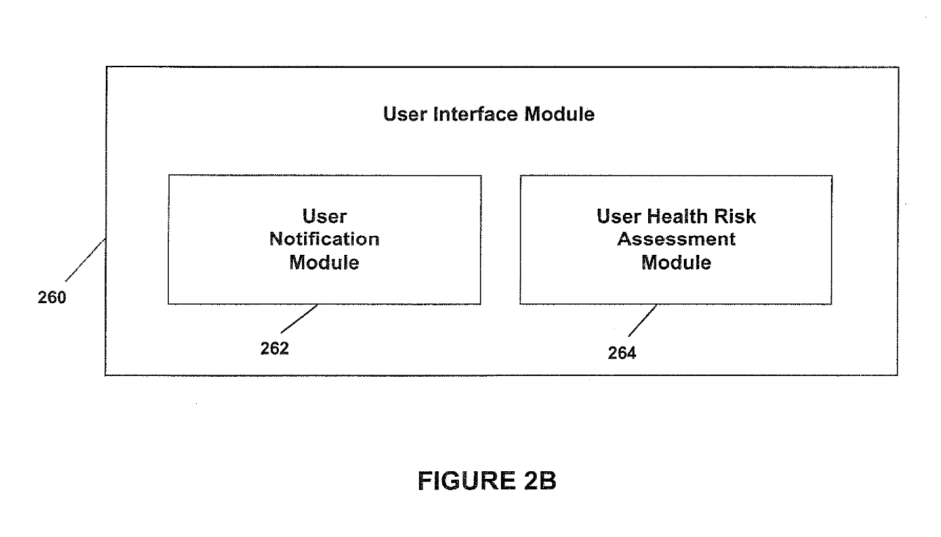

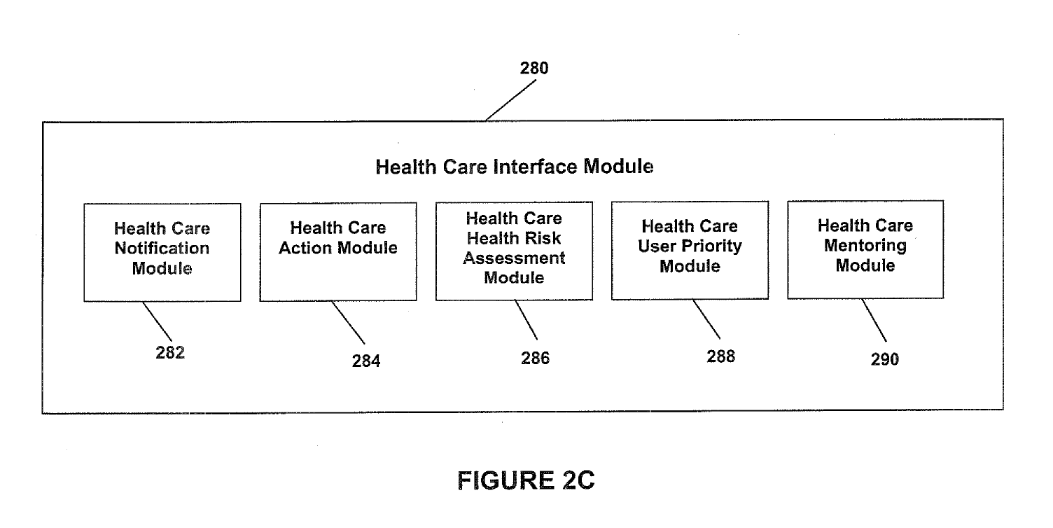

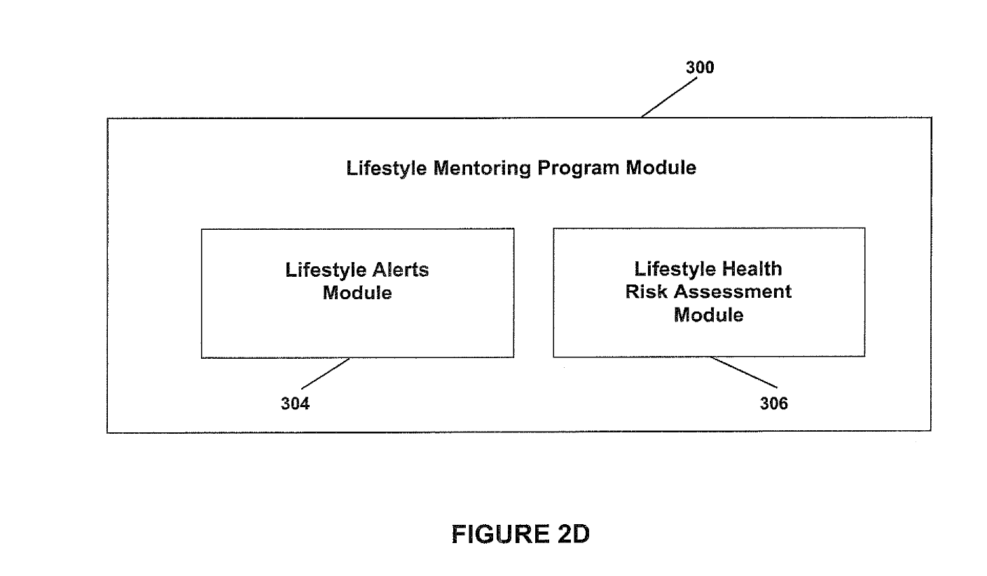

Referring to FIG. 2, an embodiment of pharmaceutical module 106 is shown. When a user, using user workstation 114, logs into pharmaceutical module 106, for example using a unique user ID and password or a unique coupon, user interface module 260 can collect and modify user health risk assessment data directly from a user using user workstation 114. User interface module 260 can additionally notify a user of alerts or actions that require their attention and can allow a user to interact with other health care providers associated with the user, including lifestyle coaches/mentors of programs in which the user has been enrolled.

When a pharmacist (or other health care provider), using health care provider workstation 112, logs into pharmaceutical module 106, for example using a unique user ID and password, health care interface module 280 can modify user health risk assessment data directly from a pharmacist using health care workstation 112, health care interface module 280 can notify a pharmacist of particular alerts or actions that require their attention and additionally can prioritize these alerts. Additionally, health care interface module 280 can allow a pharmacist to interact with the user or other health care providers associated with the user, as well as to enroll a user in a mentoring program.

Skilled persons will appreciate in other embodiments additional modules configured for use by an alternative health care provider, such as a physician, lifestyle coach/mentor, dietician, counselor, employee assistance program provider, diabetes education counsellor, or other health care provider can be added to pharmaceutical module 106.

Users can participate in a program administered by pharmaceutical module 106 by purchasing in-store coupons that can be available at retail outlets such as pharmacies, or can be offered for sale by their physician. A user who has purchased a coupon can access pharmaceutical module 106 through user workstation 114 for example, by accessing a home page for purchasing module of pharmaceutical module 106. For example, user workstation 114 can be a home computer connected to network 108 which may be the Internet, which is further connected to pharmaceutical module 106 residing on server 104 of pharmaceutical information system 102. The coupon purchased by the user contains a code, or unique identifier, that is associated with, for example, a specific program and can additionally be associated with market tracking information, such as the retail location that sold the coupon, for the purpose of generating marketing information to monitor the success of certain programs which may be helpful in future marketing campaigns.

Once the user has entered the coupon code, user interface module 260 requests additional personal information from the user, such as name, address and other contact information and asks for the user to assign themselves a unique user ID and password (creating a user account), so the user can log into pharmaceutical module 106 on future occasions.

Once the user has created a user account, the user is requested to complete a health risk assessment and user health risk assessment module 264 requests that a health risk assessment module 202 administer a health risk assessment to the user. In the embodiment shown, health risk assessment module 202 retrieves health risk assessment questions from health risk assessment questionnaire database 204 and the user is requested to answer these questions using user workstation 112. Responses are provided using a user interface on user workstation 114, such as keyboard, mouse, touch screen or other user input device, and the responses are stored in health risk assessment response database 206.

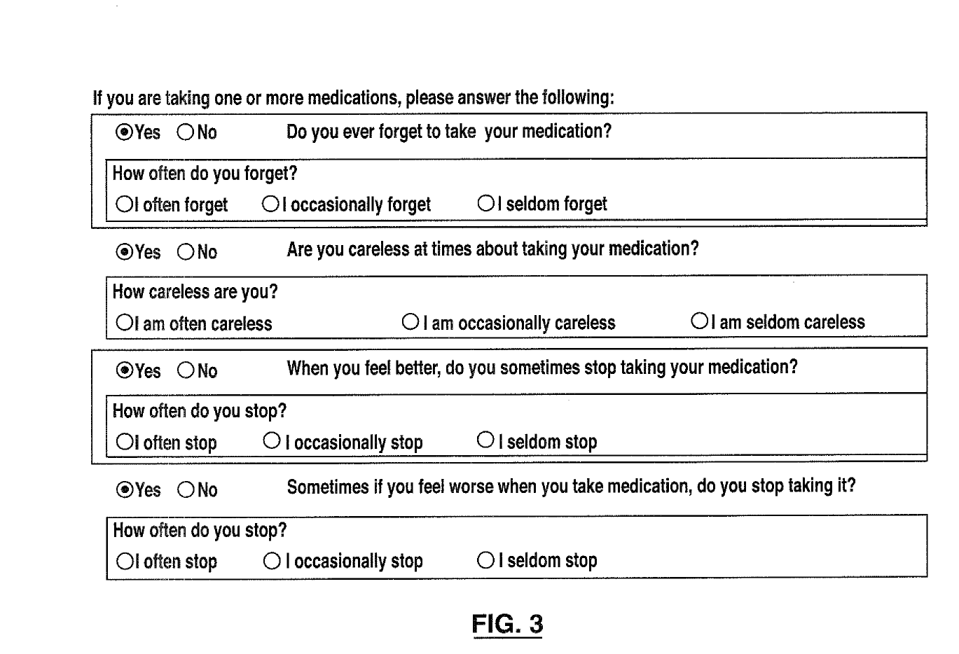

In some embodiments, health risk assessment questionnaire 204 can include a Morisky scale survey as described in Morisky D A, Green L W, Levine D M. Med Care. 1986 January, 24(1):67-74, the contents of which are hereby incorporated by reference. In other embodiments, the questions stored in health risk assessment questionnaire 204 can be a modified Morisky scale, which can include additional degrees of non-adherence to affirmative responses to any of the original questions and can be answered for each individual medication. An example of questions provided to user on user workstation 114 from a modified Morisky scale is shown in FIG. 3.

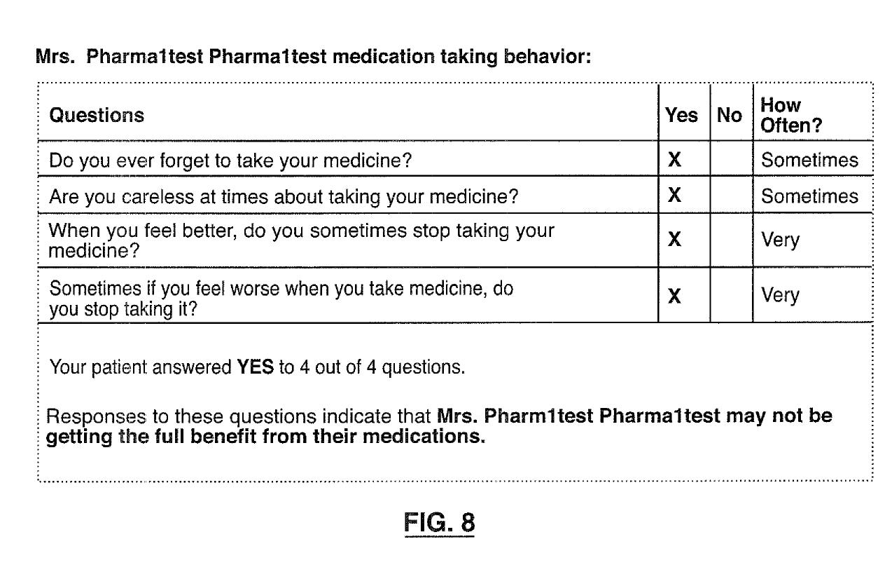

Questions included in health risk assessment questionnaire 204 can include medication-related questions, including, for example, questions related to current medication being taken by a user, the frequency the medication is taken, the preparation of the medication, the dosing regimen of the medication and reasons for taking the medication. These medication related questions can additionally include questions related to allergies of the user, dosing regimens, diseases for which the medications are taken, dosing frequency and medication behaviors such as whether the user has stopped or discontinued their medications without instruction from their physician or other health care provider. An example of questions that can be provided related to medication behaviors is shown in FIG. 8.

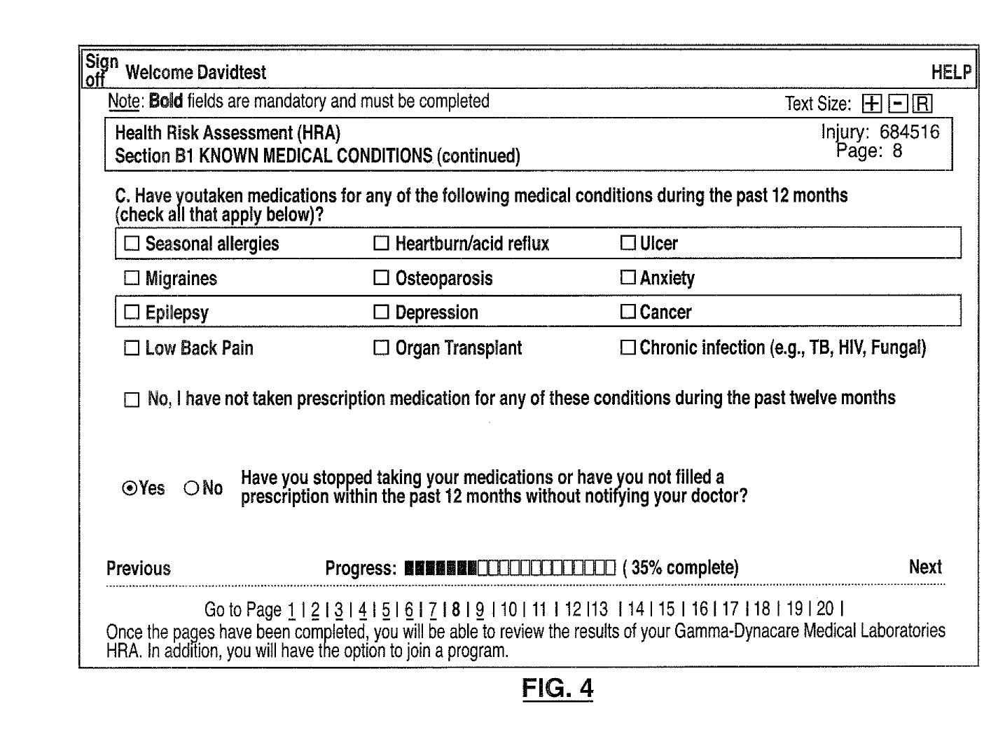

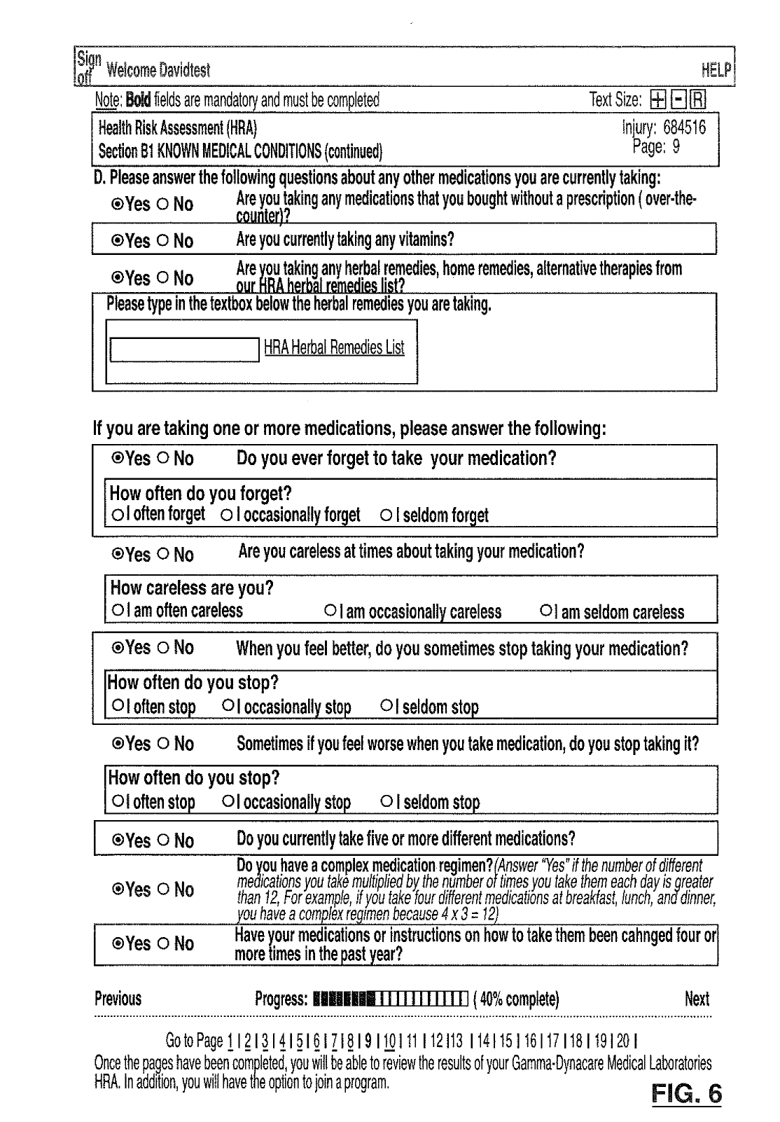

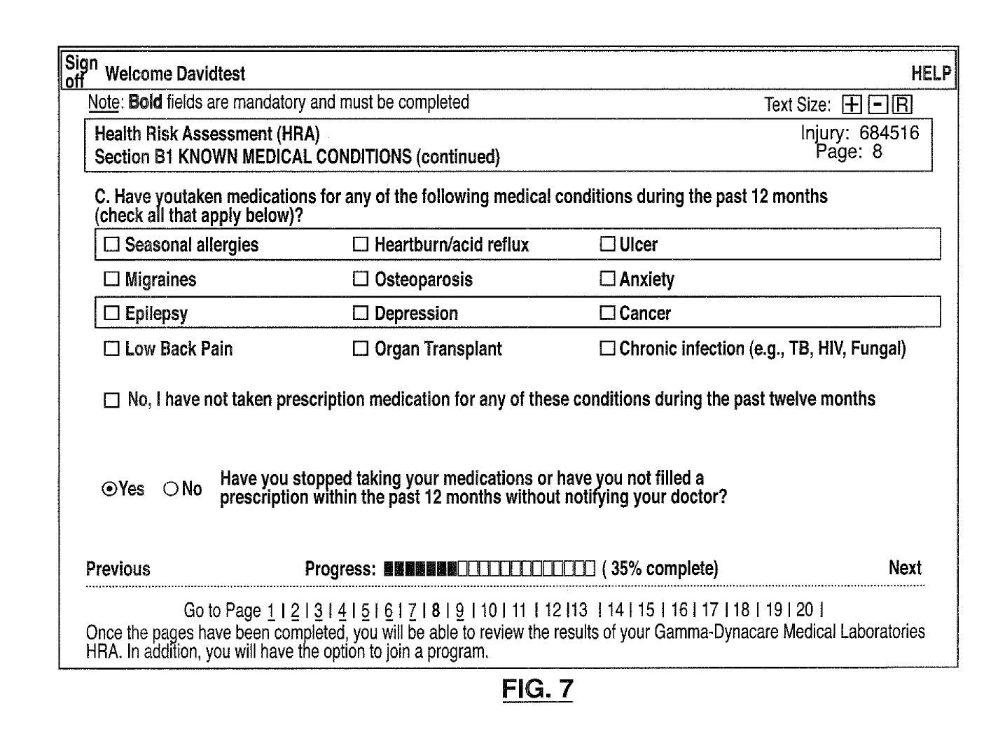

Additionally, these medication-related questions can include questions to identify over-the-counter medications and specific herbal products taken by the user. FIGS. 4, 5, 6 and 7 show representations of the display screen of user workstation 114 when the health risk assessment is being administered.

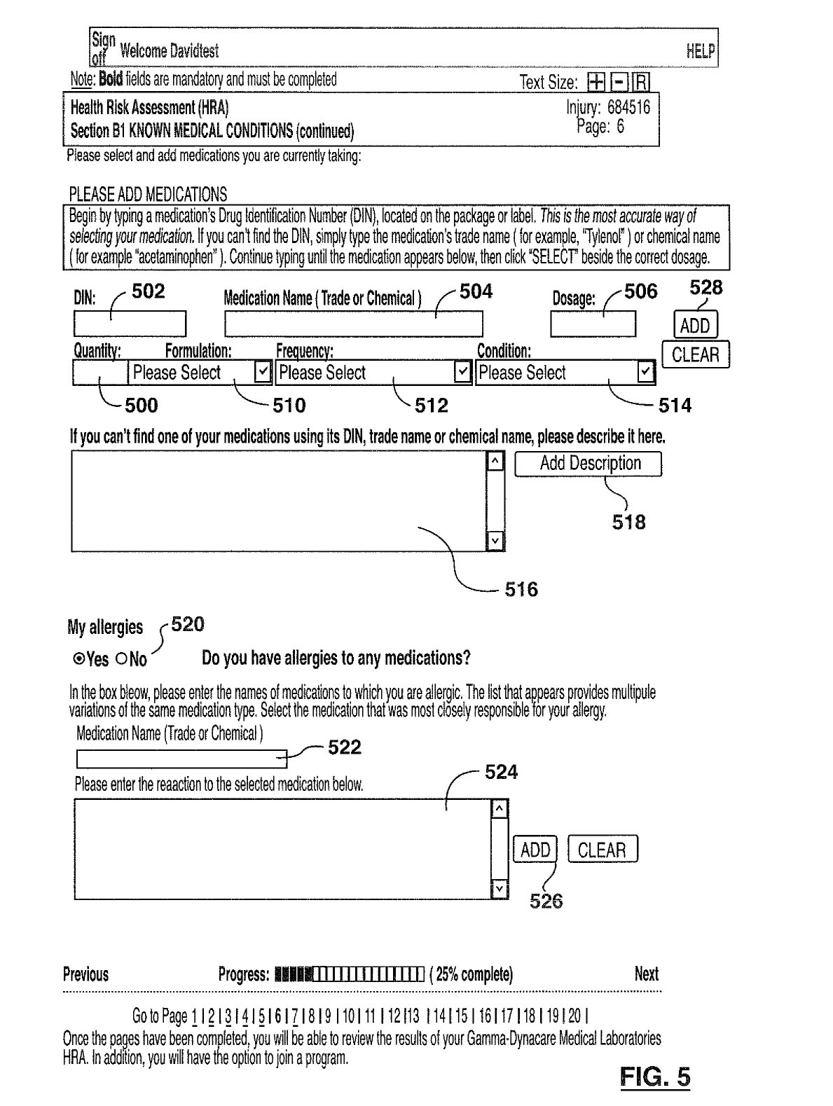

With reference to FIG. 5, as part of the health risk assessment, a user provides pharmaceutical module 106 with the current prescription medications they are taking A user can enter the Drug Identification Number (DIN) number of a drug at 502, the trade name of the drug at 504, the dosage of the drug at 506, the quantity of the drug they are taking at 508, the formulation of the drug they are taking at 510 (which, in the embodiment shown is a drop down list that is selectable by the user), the frequency that they are taking the drug at 512 (which, in the embodiment shown is a drop down list that is selectable by the user), the condition for which they are taking the drug at 514 (which, in the embodiment shown is a drop down list that is selectable by the user) and, if the information is not available, the user can enter in any additional information in text field 516. The user can add the description provided in the text box using “add description” button 518 and can add the prescription drug they are currently taking to health risk assessment response database 506 by pressing “add” button 528. Additionally, a user can identify if they have any known drug allergies, as well as the drug they are allergic to at 522 and the reaction they have of the drug at 524. This information is added to health risk assessment response database 506 by pressing “add” button 526.

In some embodiments, entry of DIN number 502 can cause trade name 504 to auto populate with the trade name of the drug associated with DIN number 502 and dosage 506 of the drug, by looking up the DIN number in a drug database, which may be local to pharmaceutical module 106 or may be available on another system and accessible over a network connect, such as the Internet. Additionally, entry of the DIN number of the drug can pre-populate the selectable options in formulation drop down box 510, frequency drop down box 512 and condition drop down box 514 to include only the known formulations of the identified drug, usual frequencies that the identified drug is being taken for and the known conditions for which the identified drug is being taken.

In other embodiments a user can be referred to a program administered by pharmaceutical module 106 by an employee assistance program. In such embodiments, employer can participate in employee assistance programs provided by employee assistance providers, such as third party private insurance companies. In such embodiments the employee assistance provider may have been provided with an employee eligibility file, containing information of eligible employees enrolled the employee assistance program.

Employees can be contacted by employee assistance providers to inform them of programs available through pharmaceutical module 106, and employees may choose to enroll themselves in such programs. In such circumstances employees, using user workstation can access and create a user account with pharmaceutical module 106 to enroll themselves in a program. In such embodiments the employee will provide a unique identifier to establish that they are eligible to be enrolled in the programs provided by pharmaceutical module 106, for example an employer plan number and employee number.

Once the employee has created a user account a request for a health risk assessment can be sent by user risk assessment module 264 to health risk assessment module 202 and the health risk assessment can be administered as described above.

In other embodiments, when an employee does not sign up for any programs or create a user account with pharmaceutical module 106, an employee assistance provider can follow-up with employees and suggest specific programs that may be suitable to the employee based on information available to the employee assistance provider, such as recent claims made by an employee. The employee assistance provider can call or send an electronic message to the employee to obtain their consent to have a health care practitioner associated with the employee assistance provider contact the employee. If the employer agrees, the employee assistance provider records a log of this consent in log file 230 which prompts health care notification module 282 to send an electronic notification to the health care provider.

The health care provider can contact the employee to discuss the program and can enroll the employee into the program. In some embodiments the health care provider can access pharmaceutical module 106, by logging in using a unique ID and password and health care risk assessment module 286 can request that health risk assessment module 202 administer a health risk assessment. In such embodiments the health care provider may ask the questions to the employee and provide responses using health care workstation 112 to generate a set of health risk responses associated with the employee for storage in health risk assessment response database 206.

In other embodiments, the health care provider can direct the employee to create a user account on pharmaceutical module 106 using user workstation 114 and in such embodiments user health risk assessment module 264 requests that health risk assessment module administers a health risk assessment as described above.

In some alternative embodiments, a user can purchase programs through an online website. For example, a user may access the website of a program provider which displays programs available, and the user can select certain programs for purchase. In some embodiments, the user can click on links associated with each program they wish to purchase and the program can be placed in the user's electronic shopping cart. The user can then purchase all items in the shopping cart once they have reviewed and selected each program they wish to enroll in. Once the programs have been purchased, the user can be directed to create a user account, or can create the user account at a later time. When the user creates a user account, the health risk assessment can be administered to the user as described above.

A user can update their responses to a health risk assessment in health risk assessment response database 206. User health risk assessment module 264 can receive a communication from user workstation 114 that a user needs or would like to update the health risk assessment data associated with them, for example if the user is no longer taking a medication, is taking a new medication, or, for example, if the user learns of a new allergy. In such situations, user health risk assessment module 264 can request that health risk assessment module 202 administer a new health risk assessment using questions stored in health risk assessment questionnaire 204. In some embodiments, health risk assessment module 202 can administer an updated health risk assessment asking only the required questions to be updated, which can be selected by the user. In other embodiments, health risk assessment module 202 can access the user current responses stored in health risk assessment response database 206 and allow the user to edit or modify the current responses. In some embodiments, the health care provider, using health care workstation 112, can log into pharmaceutical module 106 and request follow-up health risk assessments be administered to a user. Such requests can be logged in log file 230 and can cause user health risk assessment 264 to request a follow-up health risk assessment be administered by health risk assessment module 202 when a user next logs into pharmaceutical module 106. In addition, user notification module 262 can send an alert, for example by email, to a user to inform them that a request to update their health risk assessment has been logged in log file 230 by the health care provider.

Pharmaceutical module 106 includes log file 230 in which information such as actions taken by users, health care providers or lifestyle coaches/mentors can be logged in one centralized location. Information stored in log file 230 can be accessible by user interface module 260, health care interface module 280 and/or lifestyle mentoring program module 300, and can, in some embodiments, trigger other actions to occur, such as notification to make appointments, contact a health care provider, or provide additional information about a user.

Pharmaceutical module 106 includes alerts module 220 for determining alerts for a user based on responses to the users health risk assessment stored in health risk assessment response database 206. For example, affirmative or negative responses to specific responses by a user, and/or specific combinations of responses, can be analyzed by alerts module 220 and can generate a specific alert.

In the embodiment shown, alerts module 220 evaluates the responses provided by a user and stored in health risk assessment response database 206 upon receiving the responses, in real-time or near real-time. In some embodiments, alerts module 220 can evaluate the responses as responses are being provided by a user and in other embodiments, immediately upon completion of a health risk assessment all responses for that user stored in health risk assessment response database 206 can be provided to alerts module 220 for evaluation and the generation of alerts. The alerts generated by alerts module 220 can be related to a number of chronic diseases, and can include cardiovascular risk alerts, a body mass index alert, a stress risk alert, a hypertension alert, a cholesterol level alert, a diabetic alert, a depression alert, a cancer alert, a high risk pregnancy alert, an asthma alert, a chronic obstructive pulmonary alert, and a medication risk alert; however, skilled persons will appreciate that alerts associated with other chronic diseases can be generated by alerts module 220.

In some embodiments, alerts can include a notification that a user is taking over-the-counter medications that cause some interactions issues with prescription medications the used identified in the health risk assessment. Alerts can additionally be generated if a patient identified five of more prescription medications as medications they are currently taking. Such an alert can, for example, indicate a higher risk factor that can additionally affect a user's risk score assessment determined by risk score assessment module 240. Additionally, if a user provided responses that they have missed taking medications, or on some occasions have stopped taking medications without instructions from their health care provider, this can trigger an alert indicating that this user may require additional monitoring or mentoring from a pharmacist, or other health care provider.

In some embodiments, the responses stored in health risk assessment response database 206 can be modified at a later date, for example, a user may cease to take a certain medication, or may be taking a new medication, and the user can update their responses stored in health risk assessment response database 206 to reflect these changes by logging into pharmaceutical module 106 and using user health risk assessment module 264 to access the user's current health risk assessment response database 206 to modify their health risk assessment responses. In such embodiments, upon a modification of responses stored in health risk assessment response database 206, alerts module 220 can immediately re-evaluate such responses and, can remove alerts or add new alerts, if appropriate based on the updated responses.

In the embodiment shown in FIG. 2, alerts module 220 can store alerts in user alerts 222 and health care provider alerts 224. If an alert is generated by alerts module 220 that will be communicated to a user, this alert is stored in user alerts 222. Alternatively, if an alert is generated by alerts module 220 that will be communicated to the health care provider associated with the user, that alert is stored in health care provider alerts 224. Skilled persons will understand that if other health care providers, such as physicians, lifestyle coaches/mentors, counselors, dieticians, diabetes educators, employees assistance providers, are associated with an identifiable user, alerts module can store alerts specific to those health care providers. For example, alerts module 220 can generate an alert based on a user's nutritional profile and this alert can be communicated to the user's dietician. In other embodiments counselors and employee assistance providers can receive applicable alerts generated by medication alerts module 220.

In some embodiments, alerts can be stored in multiple databases, if the same alert will be communicated to two or more individuals. Additionally, skilled persons will appreciate that in some embodiments, alerts can be stored in a single database, and through the use of database flags, the alerts can be associated with the user or a particular health care provider for that user.

In other embodiments, alerts module 220 can generate alerts based on user action. For example, in some embodiments, alerts may be generated by alerts module 220 if a pharmacist assigns a quick-tip document to a user, or a lifestyle coach/mentor sends a notification to a user's physician of an issue to follow-up on. In other embodiments, an alert can be generated by alert module 220 if a member of the user's health care provider team, such as a user's pharmacist, assigns a user to a mentoring program. In some embodiments when these alerts are generated by user action, for example if a pharmacist wishes to notify a physician of a new drug reaction associated with the user, the pharmacist can log this information to log file 230 which can trigger health care action module 284 to request that health care notification module 282 send a notification alert to the physician or other appropriate health care provider.

Additionally, in some embodiments, members of the user's health care provider team, such as the user's pharmacist, physician or lifestyle coach/mentor can provide additional responses or updated responses stored in health risk assessment response database 206 for a user, which can then be provided to medication alerts module 220 and can result in new alerts being generated.

Alerts generated by alerts module 220 can be provided to the intended recipient, such as the user or a health care provider associated with the user, such as the user's pharmacist, physician or lifestyle coach/mentor, through the health care notification module 282. For example, in the embodiment shown in FIG. 2, user notification module 262 can provide a notification to a user, for example, by email, that a new user alert has been associated with the user. Health care notification module 282 can similarly provide notifications to a health care provider, such as a pharmacist that new health care alerts 224 are available for viewing. Skilled persons will appreciate that in other embodiments where the user is associated with different or additional health care providers, such as counselors, dieticians and employee assistance providers, that similar notifications can be provided to those health care providers to advise them that new alerts, specific the respective health care provider, are available for viewing.

Risk score assessment module 240 receives alerts generated by alerts module 220 and can additionally access health risk assessment response database 206 for analysis and the generation of a risk assessment score for a user, which is stored in risk assessment score database 242. Risk score assessment module 240 can determine an overall risk score of a user taking into account factors such as a user's height, weight, age, pre-existing medical conditions, current medications, and other responses provided by the user on their health risk assessment. The overall risk score, in some embodiments, is representative of the patient's overall health, for example, a high overall risk score may be representative of a poor overall health, the user having a high risk of developing or having health related problems.

In some embodiments a medication risk score can be determined, the medication risk score indicative of the risk that a user may not follow their prescription drug administration regimen for a particular medication they have been prescribed. Alerts generated by alerts module 220 can be differentially weighted and tallied using, for example, algorithms to generate a numeric and a qualitative risk score for a user. The numeric summative medication risk score is generated using a weighted score-based algorithm from 0 (meaning there are no medication related safety, appropriateness, and/or behavioral issues) to 4 (meaning there are many medication related safety, appropriateness and/or behaviors issues). The qualitative summative medication risk score can use the same alerts but classifies users into risk categories for drug related concerns and issues, such as low, medium, slightly higher than average, higher than average, or high risk. Skilled persons will understand that a weighted score-based algorithm from 0 to 4 is provided by way of example, and other numeric weighing can be applied to a medication risk score.

For example, in some embodiments, a user can be assessed a low medication risk score if they are currently taking no prescription medications. A user can be assessed a medium medication risk score if they are taking medications for two or more pre-existing health conditions. Further, a user can be assessed a high medication risk score if they have multiple treated conditions, are taking multiple prescription medications, their prescription medication administration regiment is complex, they are taking multiple prescription medications with a potential for undesirable drug interactions, or the user is assessed as a high risk for not adhering to their prescription drug administration regiment (i.e. the user has a history of forgetting or stopping taking their prescription medications).

Report generation module 340 generates a summary report based on the overall risk score and medication risk score for a user determined by risk score assessment module 240 and stored in risk score data 242, alerts generated by alerts module 220, as well as health risk assessment responses stored in health risk assessment response database 206. The reports generated can be specific to the user or a health care provider associated with the user. For example, report generation module 340 can store a report for viewing by a user in user report 342 or a report for viewing by a pharmacist in health care provider report 344. Skilled persons will appreciate that similar reports specific to other health care providers, may be generated by report generation module 340 and similarly stored for viewing by those other health care providers associated with an identifiable user.

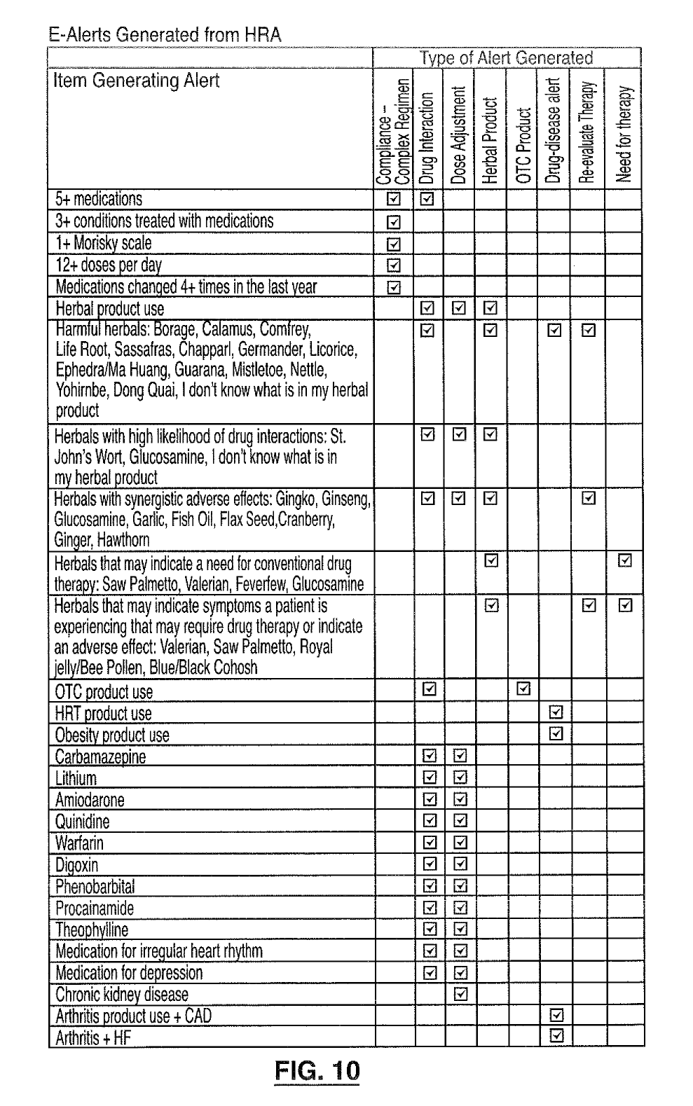

In some embodiments report generation module 340 can generate a report showing each alert for a user which can be viewed at user workstation 114 or health care workstation 112. For example, FIG. 10 shows an embodiment of an alert report. In some embodiments separate alert reports can be generated by report generation module 340, for example a report for a user stored in user report database 342 and a separate report for a health care provider, stored in health care provider report database 344. In such embodiments, certain alerts may be appropriate to only send to a user while others may be only appropriate to send to a health care provider and the separate alert reports reflect this.

In some embodiments, language tables can be used by report generator to translate between languages of a report. For example language tables can provide a mapping of terms between two or more languages for translation and can be configurable by a system administrator. Reports generated by report generation module 340 provide a summary of the overall risk score and the medication risk score of a user determined by risk score assessment module 240 and stored in risk score database 242.

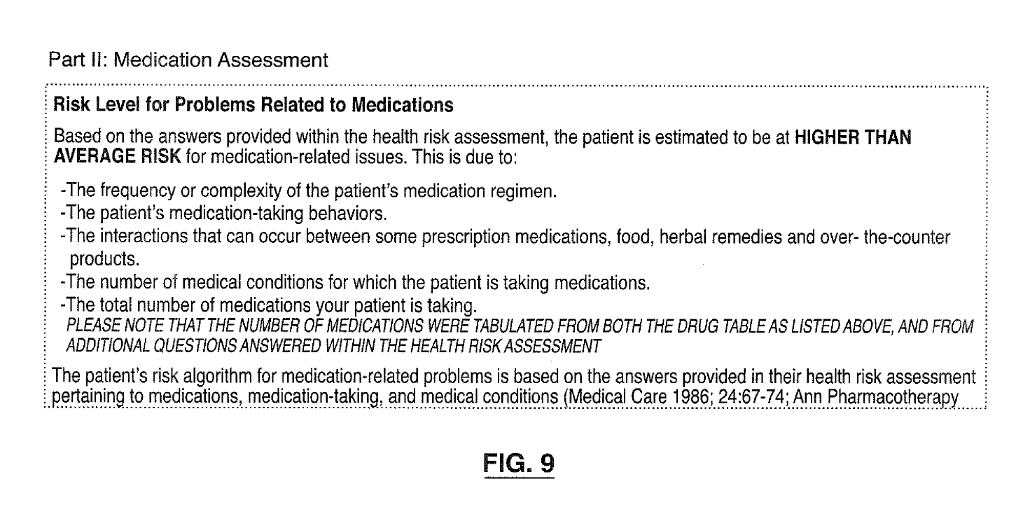

An example of a user medication taking risk report is shown in FIG. 9. In the embodiment shown in FIG. 9, the user's health risk assessment score concluded that the user is at a higher than average risk, due to the frequency or complexity of the user's medication regime, the user's medication taking behaviors (for example, the user may, on occasion forget to take medication), certain drug interactions that might occur as well as the number of medical conditions for which the user is taking medications.

User notification module 262 can notify a user, for example by email, that a new report is available for viewing. The user can then log into pharmaceutical module 106 and user interface module 260 can access the new user report 342 for viewing on user workstation 114. In some embodiments, user report 342 may additionally store historical reports, which can additionally be displayed to the user on user workstation 114, if the user wishes to view older reports, for example, if they would like to compare reports to track their progress. In some embodiments, the notification can provide a summary of the specific alert and may additionally briefly describe its significance. Similarly, health care notification module 282 can notify the pharmacist that a new report is available for viewing. The pharmacist can then log into pharmaceutical module 106 through health care workstation 112 and health care interface module 280 can provide access to health care provider report 344.

Based on the alerts and reports provided to the health care provider, the provider may choose to begin some user coaching/mentoring with the user through telephonic or electronic communication with the user using pharmaceutical module 106. In some embodiments, coaching/mentoring by a pharmacist or other health care provider can be supplemented with telephone and in-person mentoring, the record of which can be logged in log file 230 and can additionally prompt updates to the health risk assessment response database 206 associated with a user.

Health care action module 284 allows a pharmacist, using pharmacy workstation 112, to respond to alerts or user risk assessment reports provided by medication alerts module 220 and report generation module 340. For example, a pharmacist may review an alert report and health risk assessment report, and based on this review, the pharmacist may choose to do nothing. In such an example, pharmacist can acknowledge they have reviewed the alert or report and health care action module 284 will log that the pharmacist has elected to take no action in log file 230.

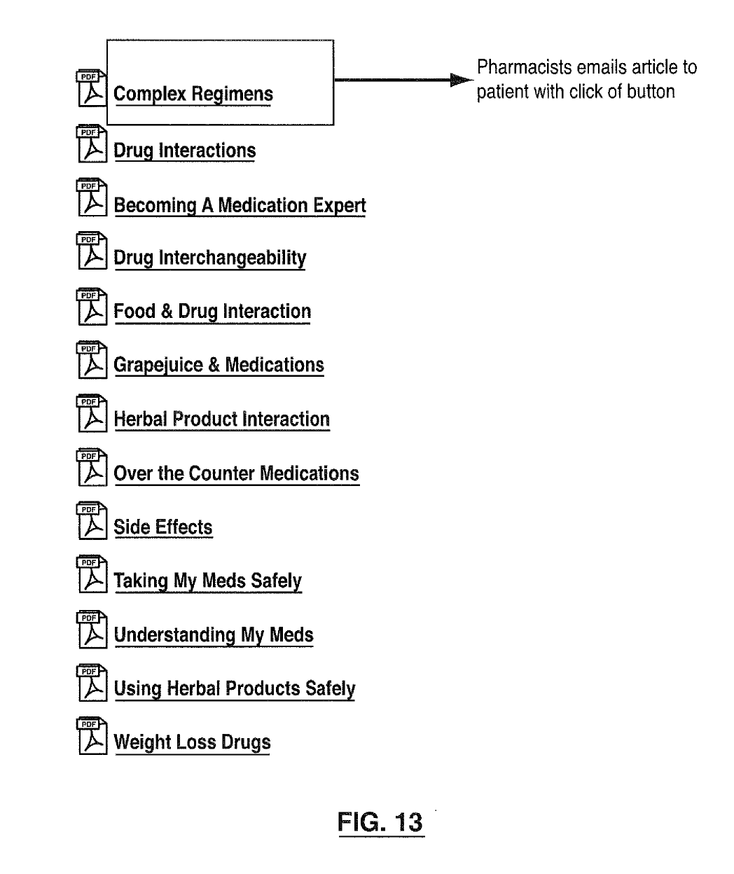

In another example, the pharmacist may choose to send an electronic message to a user, the action being logged into log file 230, which can generate a new user alert 222, which can be sent to the user by user notification module 262. The pharmacist can attach certain educational materials to the electronic message, and if they choose to do so, health care action module 284 can access education module 360 which can provide a listing of articles 362, educational materials 364 and quick-tip materials 336 that can be selected by the pharmacist to attach to the electronic message. In some embodiments, quick-tips can address issues of treatment gaps and can draw awareness to the fact that certain evidence based medical therapies are underutilized among users with risk factors, diseases, and/or disease complications. FIG. 13 shows an embodiment of a user interface for selecting materials to attach to a notification.

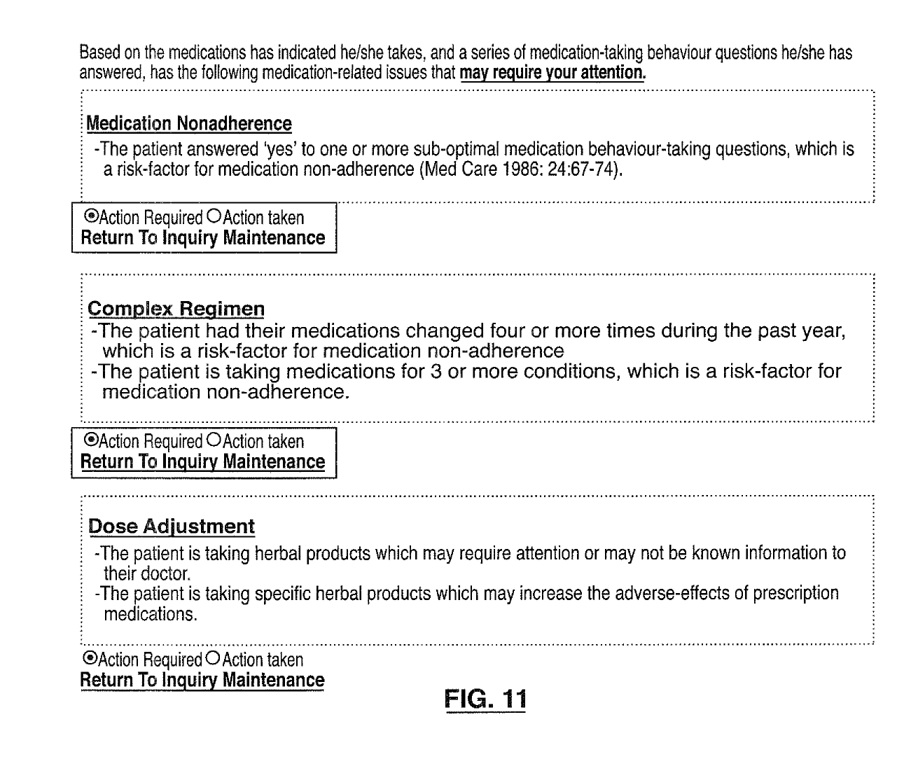

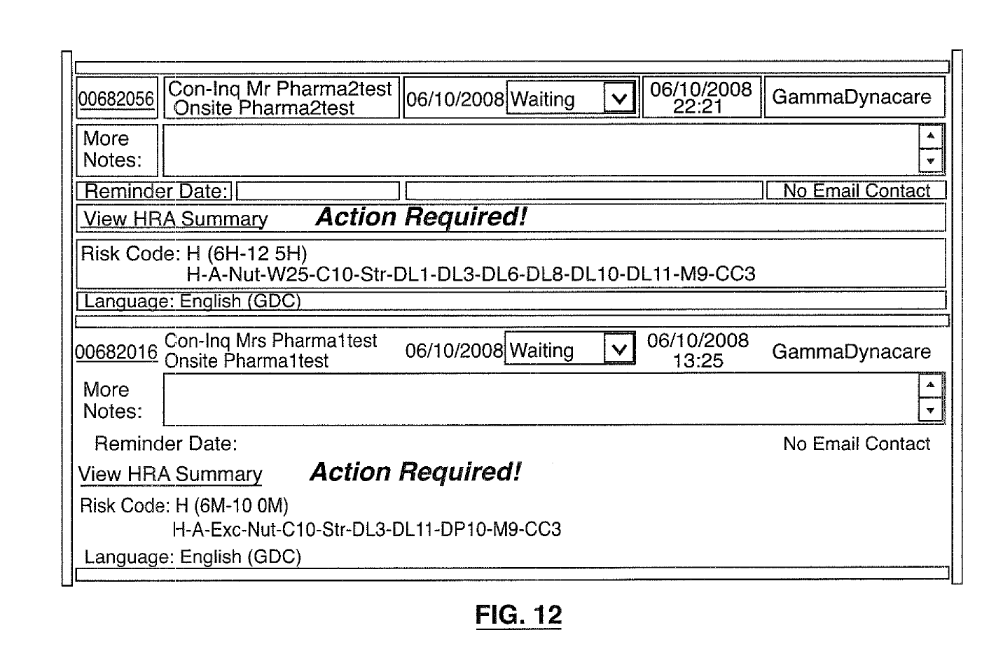

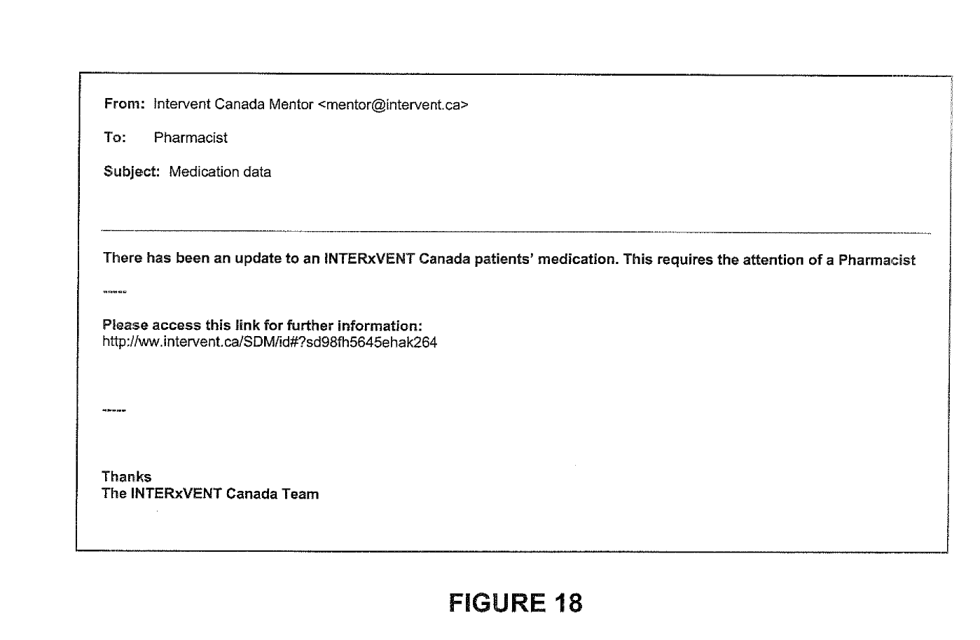

In other embodiments, the health care action module 284 can schedule a telephone appointment to contact the user and discuss any issues regarding the reported alerts or alarms further and can log this action to log file 230. In some embodiments, health care action module 284 may require specific responses or actions to take place, and in other embodiments, the pharmacist responses may be unstructured, or left to the discretion of the pharmacist. FIGS. 11 and 12 show embodiments of notifications that can be provided to a pharmacist through health care notification module 282 that can prompt health care action module 284 to take certain actions and FIG. 18 shows an embodiment of a notification email to a pharmacist.

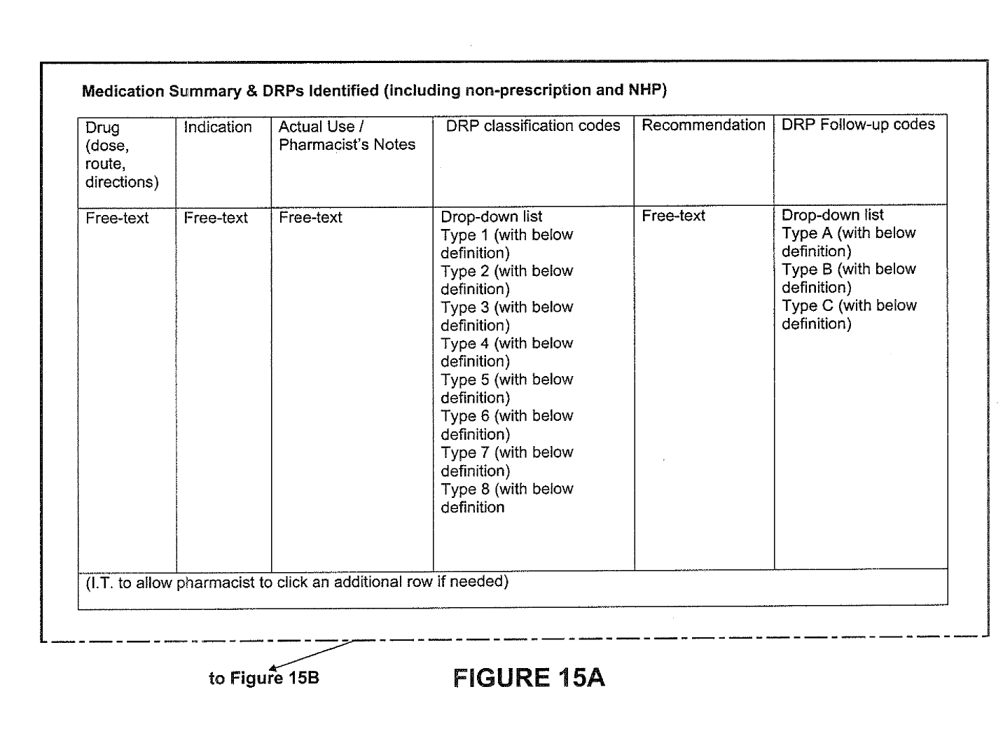

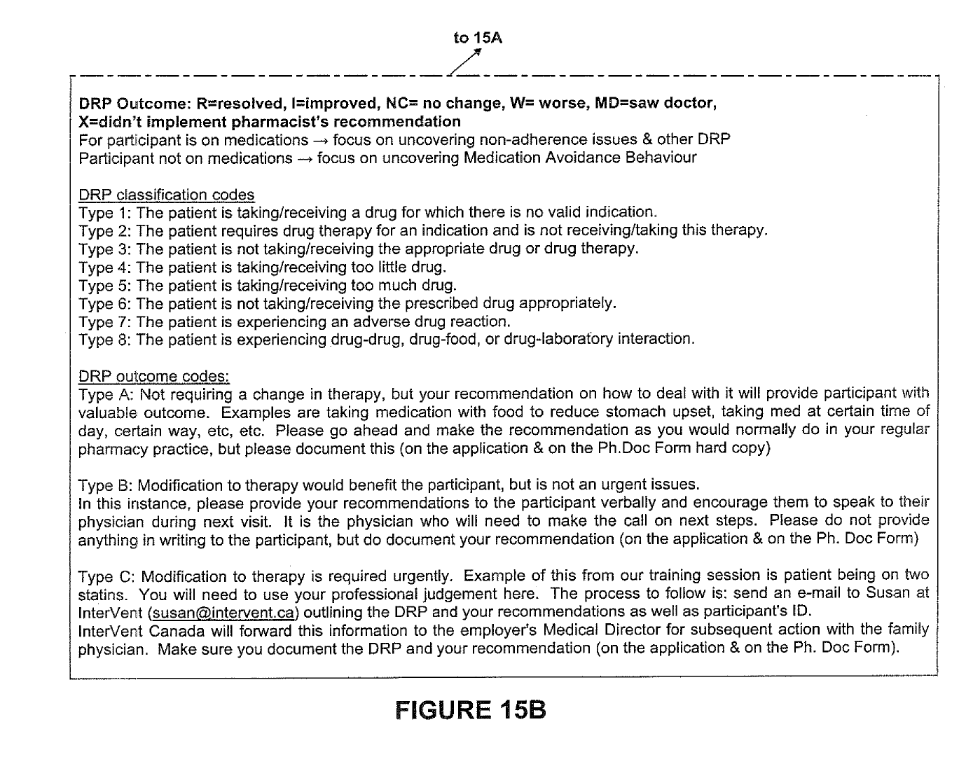

Action items can be documented to log file 230 by health care action module 284 using a documentation template that is a combination of free-text and drop down items for classifying issues according to drug related problems. FIG. 15 shows an embodiment of a documentation template that health care action module 284 can display to a pharmacist through health care workstation 112 that can be used by pharmacist to document action items and store the documented action items within pharmaceutical module 106.

Health care user priority module 288 reviews the alerts generated by medication alerts module 220 for each on an individual user basis, and, in some embodiments, in respect of each user associated with that health care provider. Health care user priority module 288 can triage which users to contact and how many estimated visits may be required to address the medication issues that arise. In some embodiments, a weighted algorithm tallies the number and types of alerts and can provide a recommended number of calls to address each alert appropriately.

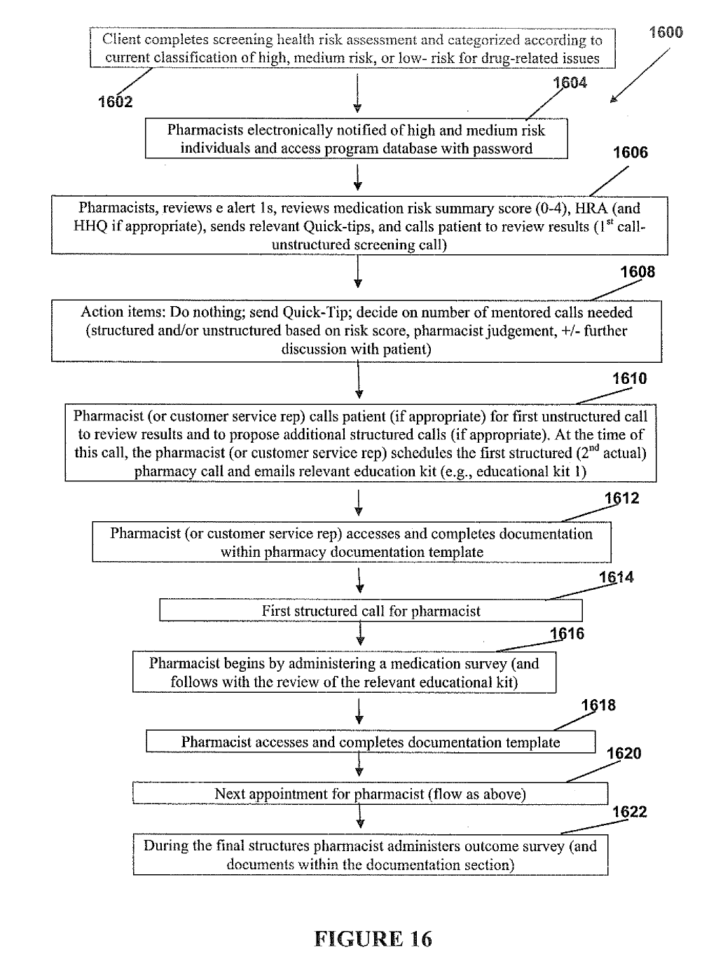

With reference to FIG. 16, process 1600 is shown for generating alerts and reports based on a user's health risk assessment responses and for pharmacist mentoring of a user. At 1602, a user logs into pharmaceutical module 106 and user health risk assessment module 264 requests that health risk assessment module 202 administer a risk assessment questionnaire using the questions stored in health risk assessment questionnaire database 204 and stores the user responses entered using user workstation 114 in health risk assessment response database 206. In addition, at 1602, alerts module 220 generates alerts based on the responses stored in health risk assessment response database 206 and risk score assessment module 240 generates an overall risk assessment score and a medication risk assessment score, which are store in risk assessment score data 242, associated with the user. In some embodiments, the user can be classified into a group of high, medium or low risk for drug related issues. Report generation module, at 1602, additionally generates a report based on the alerts produced by alerts module 220 and the risk assessment scores.

At 1604, health care notification module 262 electronically transmits a notification, for example by email, to the pharmacist to notify the pharmacist of the risk score of a user. In some embodiments, health care user priority module 288 can filter the notifications such that health care notification module 282 only provide medium and high risk alerts notifications to the pharmacist.

At 1606, the pharmacist reviews the alert notifications and reports generated by report generation module 340, including the risk assessment score of the user. Additionally, at 1606, the pharmacist can send electronic educational materials obtained by education module 360, including articles 362, educational materials 364 and quick-tip materials 366 to a user by creating a log entry in log file 230, where health care action module 284 generates the log entry. The pharmacist can additionally contact the user, electronically or in some embodiments by telephone, to review the results with the user, and in some embodiments follow-up questions may be provided to the user, electronically or, in some embodiments by the pharmacist, the responses being logged to log file 230 and, if applicable, updating previous responses stored in health risk assessment response database 206. In some embodiments, after the generation of the log entry in log file 230 by a pharmacist, based on the logged entry, user notification module 262 can send a notification to a user regarding the logged entry, for example, to notify them of an appointment, or to make an appointment.

At 1608, health care action module 284, based on input received from the pharmacist at pharmacy workstation 112 and logged to log file 230, can acknowledge action items regarding the alerts generated by 220 which are additionally logged to log file 230. As discussed above, in some embodiments, the pharmacist may elect to do nothing in response to an alert, and health care action module 284 can acknowledge the alert and log the decision to do nothing to log file 230. In other embodiments, health care action module 284 can assist the pharmacist to develop a pharmacist mentoring plan which can include calls to the user, the action plan being logged to log file 230. In some embodiments, the number of calls can depend on the overall risk assessment score of the user, which can additionally be displayed in reports generated by report generation module 340 and may be adjusted based on further discussion with the user or changes to the user health risk assessment response database 206.

At 1610, the pharmacist contacts the user for the first call to review the results and to propose additional calls to the user the result of which is logged to log file 230 by health care action module 284. Additionally, at 1610, the pharmacist can schedule the first call. At 1612, based on the review of user results at 1610, pharmacist can access, document and log to log file 284 within a pharmacy document template the results and discussion points of the call with the user.

At 1614, the pharmacist performs the first call with the user, where the pharmacist can administer follow-up questions to obtain further details and responses with respect to a user's health risk assessment, the follow-up responses provided by the user, in some embodiments, modifying or adding new health risk assessment response database 206 associated. In such embodiments, health care health risk assessment module 286 can request that a follow-up health risk assessment be administered by health risk assessment module 202 logging this request to log file 230, and where responses can be stored in health risk assessment response database 206, some responses replacing pre-existing responses if a user's risk assessment has changed. It should be noted that changes to health risk assessment response database 206 for a user can provide for new or updated alarms to be generated by alerts module 220. In addition, risk score assessment module 240 can provide an updated or new risk assessment score and report generation module 340 can provide updated or new reports.

At 1616, the pharmacist administers a medication survey to the user and follows up with a review of the relevant educational kit associated with the survey. At 1618, the pharmacist completes and documents the information of the medication survey, which, in some embodiments, can update a the health risk assessment response database 206 for a user, causing new or updated alerts to be generated by alerts module 220, a new or updated risk assessment score for a user to be generated by risk score assessment module 240 and a new or updated report to be generated by report generation module 340.

At 1620, follow-up appointments can be conducted, where such follow-up appointments follow a substantially similar structure to steps 1610 through 1618 described above. Following the final appointment with the user, the pharmacist administers the outcome survey and results of which can be logged to log file 230. For example, the outcomes of user mentoring programs can be evaluated and such evaluations can include a before and after evaluation of questions stored in health risk assessment questionnaire 204. User interface module 260 can be requested to administer an evaluation of the mentoring program and can access certain questions stored in health risk assessment questionnaire database 204 and their associated responses stored in health risk assessment response database 206 for evaluation. The evaluation can look at the historical trend of responses stored in health risk assessment response database 206 to provide an analysis of the outcome of the mentoring program and the concomitant effect on the user's risk factors.

In addition to a pharmacist coach/mentor, a lifestyle coach/mentor can be assigned to a user, for example if a pharmacist enrolls a user, or the user enrolls himself/herself in a lifestyle mentoring program, for example, a weight loss program, a stress management program, a nutrition program, an exercise training program, diabetes management program, or a smoking or tobacco cessation program. Lifestyle mentoring program module 300 administers the lifestyle mentoring program that a user is enrolled into.

Throughout the course of a lifestyle mentoring program, new medications can be started by a user, while others can be discontinued. Additionally, users can develop new side-effects or adverse reactions to one or more medications and in some cases, the user's medication taking regime or behaviors can worsen or improve over time. Lifestyle health risk assessment module 306 can access health risk assessment response database 206 associated with the user and appropriately update health risk assessment data with new medication information. Upon updates, lifestyle alerts module 304 can generate updated or new alerts, risk score assessment module 240 can generate an updated or new risk assessment score associated with the user, and report generation module 340 can generate updated or new reports associated with the user.

In embodiments where the pharmacist is not conducting on-going lifestyle coaching/mentoring, but instead a non-pharmacist lifestyle coach/mentor is associated with the user, user health risk assessment module 264 can prompt a user, once logged onto pharmaceutical module 106 through user workstation 114, with new health risk assessment questions, stored in health risk assessment questionnaire 204 and administered by health risk assessment module 202, which can include questions such as: (1) Are you taking your vitamins/minerals? (2) Have there been any changes to your medications? (3) How often in the past two weeks have you missed taking your medications? and/or (4) Have you had any new side-effects or allergic reactions? The responses provided can be processed by lifestyle mentoring module 306 to generate lifestyle alarms. In some embodiments, the responses generated can additionally cause the updating or modification of a user's health risk data in health risk assessment response database 206 and can additionally cause medication alerts module 220 to generate new or updated alerts. Additionally, risk score assessment module 240 can modify a user's risk assessment score data 242, including the user's overall risk score and/or medication risk score, and report generation module 340 can generate a new or updated report for viewing by a user or health care provider.

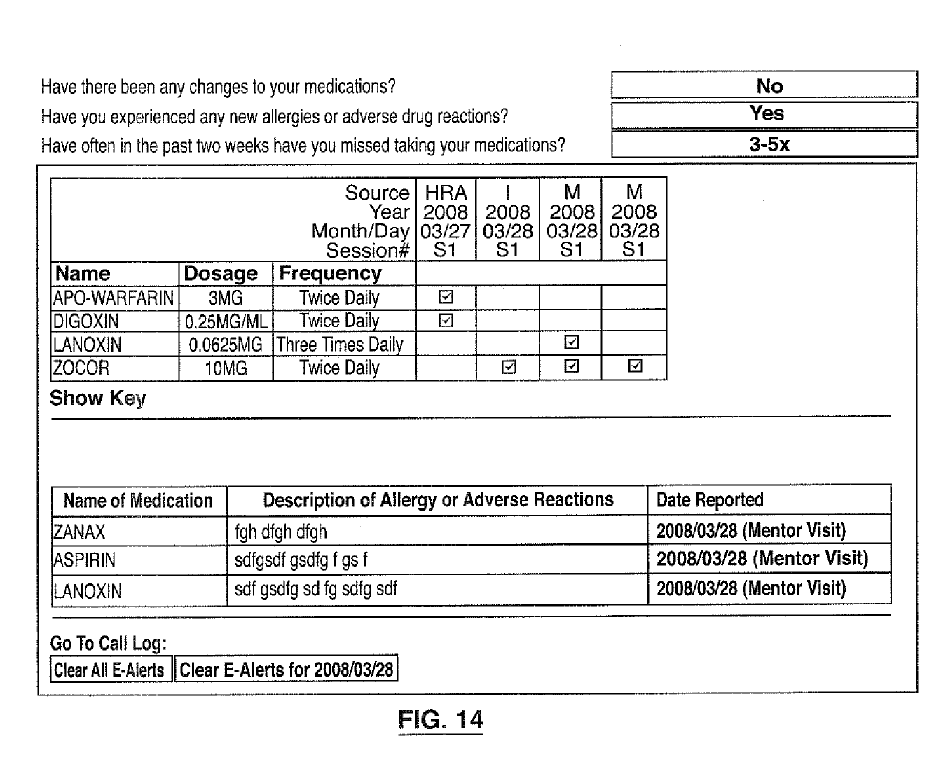

In some embodiments, when a lifestyle alert is generated, a final question can be provided asking whether the user would like to be contacted by a pharmacist to discuss the lifestyle alert. If so, health care notification module 282 can provide an electronic message to the pharmacist, that can notify the pharmacist that a new lifestyle alert has been generated with respect to the user. The pharmacist can then log into pharmaceutical module 106 to retrieve and view a summary report or the lifestyle alert in a similar manner to how other alerts generated by alerts module 220 are viewed. FIG. 14 shows an embodiment of a lifestyle alert report.

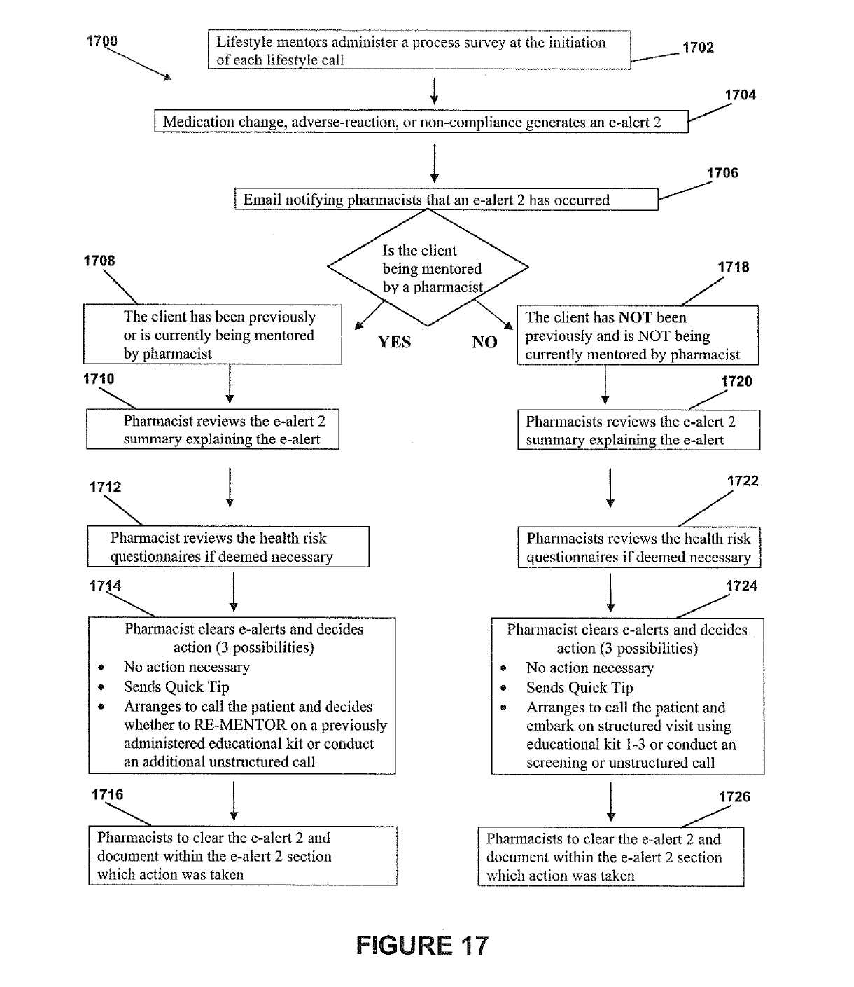

With reference to FIG. 17 process for lifestyle coaching 1700 is shown (which includes pharmacist interaction if a lifestyle alert is generated). At 1702, lifestyle mentoring program module 300 administers a lifestyle process survey to a user that is enrolled in a lifestyle mentoring program; however, in some embodiments, the survey can be administered by the lifestyle coach/mentor and input manually into lifestyle mentoring program module 300. At 1704, based on the results of the survey performed at 1702, a medication change, adverse reaction or non-compliance with a medication program lifestyle alerts module 304 can generate a lifestyle alert.

At 1706, health care notification module 282 sends notifications to the pharmacist that lifestyle alerts have been generated, prompting the pharmacist associated with the user to access these lifestyle alerts by logging into pharmaceutical module 106. At 1708, if the pharmacist is currently acting as a lifestyle coach/mentor to the user, then at 1710, the pharmacist reviews a summary of the lifestyle alerts and any reports generated by report generation module 340. At 1712, the pharmacist optionally reviews any reports generated by report generation module 340 based on the overall risk assessment score and/or medication risk score of the user stored in risk assessment score data 242.

At 1714, the pharmacist may choose to do nothing with respect to the lifestyle alerts and reports reviewed. In such an example, pharmacist can acknowledge they have reviewed the alert or report and health care action module 284 will log that the pharmacist has elected to take no action into log file 230. Alternatively, similarly with alerts generated by medication alerts module 220, the pharmacist may choose to send an electronic message to a user in response to the lifestyle alerts, which can be sent to the user by user notification module 262. The pharmacist can attach certain educational materials to the electronic message, and if they choose to do so, health care action module 284 can access education module 360 which can provide a listing of articles 362, educational materials 364 and quick-tip materials 336 that can be selected by the pharmacist to attach to the electronic message these actions being logged to log file 230 by health care action module 284. In some embodiments, quick-tips can address issues of treatment gaps and can draw awareness to the fact that certain evidence based medical therapies are underutilized among users with risk factors, diseases, and/or disease complications. In other embodiments, the pharmacist may choose to provide further mentorship to the user and health care mentoring module 290 can enroll a user in further lifestyle coaching/mentoring. In other embodiments, the pharmacist may choose to re-mentor the user on a previously administered educational kit or conduct in each case, health care action module 284 logging this determination into log file 230 which can trigger user notification module 262 to send a notification, such as an email, to the user.

At 1716, the pharmacist acknowledges and clears the lifestyle alerts that have been reviewed whether action was taken or not, where the decision of the pharmacist is logged to log file 230 by health care action module.

At 1708, if the pharmacist is not currently acting as a lifestyle coach/mentor to the user, then at 1720, the pharmacist reviews a summary of the lifestyle alerts that can be generated by report generation module 340. At 1722, the pharmacist optionally reviews the report generated by report generation module 340 based on the risk assessment score of the user stored in risk assessment score data 242.

At 1724, the pharmacist may choose to do nothing with respect to the lifestyle alerts and reports reviewed and health care action module 284 can log that decision to log file 230. Alternatively, similarly with alerts generated by medication alerts module 220, the pharmacist may choose to send an electronic message to a user in response to the lifestyle alerts, which can be sent to the user by user notification module 262 with health care action module 284 logging this decision to log file 230. The pharmacist can attach certain educational materials to the electronic message, and if they choose to do so, health care action module 284 can access education module 360 which can provide a listing of articles 362, educational materials 364 and quick-tip materials 336 that can be selected by the pharmacist to attach to the electronic message. In some embodiments, quick-tips can address issues of treatment gaps and can draw awareness to the fact that certain evidence based medical therapies are underutilized among users with risk factors, diseases, and/or disease complications. In other embodiments, the pharmacist may choose to arrange to have a mentoring call with the user and embark on a structured visit using an educational kit or can conduct a mentoring screening on unstructured call with the user.

At 1726, the pharmacist acknowledges and clears the lifestyle alerts that have been reviewed whether or not action was taken, where the decision of the pharmacist is logged to log file 230 by health care action module 284. The outcomes of user mentoring programs can be evaluated and such evaluations can include a before and after evaluation of questions stored in health risk assessment questionnaire 204 the evaluations being logged to log file 230. User interface module 260 can request an evaluation of the mentoring program be administered. The evaluation can look at the historical trend of responses stored in health risk assessment response database 206 to provide an analysis of the outcome of the mentoring program and the concomitant effect on the user's risk factors.

In some embodiments these questions can be asked at the outset of every mentored call between the lifestyle coach/mentor and the user and in such embodiments the responses can be logged to log file 230 or can result in responses stored in health risk assessment response database 206, updating pre-existing responses, which as described above can result in new or updated alarms being generated by medication alerts module 220, a new or updated risk assessment score being generated by risk score assessment module 240, and new reports being generated by report generation module 340.

The present invention has been described with regard to specific embodiments; however, it will be obvious to persons skilled in the art that a number of variants and modifications can be made without departing from the scope of the invention as described herein.

1. A system for administering a mentoring program to a user, the system comprising:
a user interface module operating on a processor for transmitting and receiving communications with a user workstation operated by the user, the user interface module having a health risk assessment module operating thereon, the health risk assessment module providing a health risk assessment questionnaire to the user, and for receiving an assessment response from the user;
the processor having an alerts module operating thereon to process the received assessment response, and based thereon, generating an alert based on the received response; the processor further having a risk score assessment module operating thereon to generate a risk score associated with the user based on at least one of the generated alert and the received assessment response; and the processor further having a report generation module operating thereon to generate a report based on at least one of the generated alert and the generated risk score associated with the user; and
a health care practitioner interface module operating on the processor for transmitting and receiving communications with a health care workstation operated by a health care practitioner associated with the user, the health care practitioner interface module having a health care notification module operating thereon for notifying the health care practitioner that at least one of the alert and the report has been generated upon the generation of the at least one of the alert and the report, the at least one of the alert and the report viewable by the health care practitioner on the health care workstation,
wherein a health care notification associated with a mentoring program is generated and provided to the user for the user's review after the at least one of the alert and the report has been viewed by the health care practitioner; and
a notification response is generated after the user's review of the health care notification and provided to the health care practitioner.

2. The system of claim 1, wherein the risk score generated by the risk score assessment module includes a medication risk score.

3. The system of claim 2, wherein the health care interface module further enrolls the user in a lifestyle mentoring program and associates the user with a lifestyle mentor.

4. The system of claim 3, wherein the system further comprises:
a lifestyle health risk assessment module operating on the processor for administering a lifestyle risk assessment questionnaire to the user through the user interface module and for receiving a lifestyle response from the user;
a lifestyle alerts module operating on the processor for analyzing the lifestyle response to generate a lifestyle alert to send to a lifestyle mentor associated with the user,
wherein the risk score assessment module further updates the risk score associated with the user based on at least one of the lifestyle alert and the lifestyle response provided by the user;
the report generation module generates a lifestyle report based on at least one of the lifestyle alert, the alert and the risk score associated with the user;
the lifestyle mentor interface module having a lifestyle mentoring program module operating thereon for notifying the lifestyle mentor that at least one of the lifestyle alert and the lifestyle report has been generated upon the generation of the at least one of the lifestyle alert and the lifestyle report, the at least one of the lifestyle alert and the lifestyle report viewable by the lifestyle mentor;
wherein the lifestyle mentoring program module generating a lifestyle notification associated with a lifestyle mentoring program for sending to at least one of the health care practitioner interface and the user interface after the at least one of the lifestyle alert and the lifestyle report has been viewed by the lifestyle mentor interface; and
a lifestyle notification response is generated from at least one of the user and the health care practitioner, based on a review of the lifestyle notification and provided to the lifestyle mentor.

5. The system of claim 4, wherein the lifestyle mentoring program is at least one of a weight loss program, a stress management program, a nutrition program, an exercise training program, a diabetes management program, and a smoking or tobacco cessation program.

6. The system of claim 4, further comprising a log file operating on the processor capable of documenting notifications and responses, the log file accessible by the user interface module, the health care interface module and the lifestyle mentoring program module.

7. The system of claim 2, wherein the alert is at least one of a cardiovascular risk alert, a body mass index alert, a stress risk alert, a hypertension alert, a cholesterol level alert, a diabetic alert, a depression alert, a cancer alert, a high risk pregnancy alert, an asthma alert, a chronic obstructive pulmonary disease alert, and a medication risk alert.

8. The system of claim 1, wherein the health risk assessment questionnaire includes questions related to at least one of lifestyle factors, user-risk factors, diseases, behavioral readiness to change, work related productivity, biometrics, and medication related issues.

9. The system of claim 1, further comprising a user priority module operating on the processor capable of triaging alerts generated by alerts module and prioritizing alerts provided to the health care practitioner in the report generated by the report generation module.

10. A computer readable medium having instructions thereon for causing a processor to execute the instructions, the instructions adapted to be executed to implement a method for administering a mentoring program to a user, the method comprising:
providing a health risk assessment questionnaire to the user;
receiving a response to the health risk assessment from the user;
generating an alert based on the received response;
generating a risk score associated with the user based on the at least one of the generated alert and the received assessment response from the user;
generating a report based on at least one of the generated alert and the generated risk score associated with the user;
notifying a health care practitioner associated with the user that at least one of the alert and the report has been generated upon the generation of the at least one of the alert and the report;
generating a health care notification associated with a mentoring program after the at least one of the alert and the report has been viewed by the health care practitioner;
sending the notification to the user; and
accepting a notification response from the user based on the user's review of the health care notification.

11. The computer readable medium of clam 10, wherein the risk score generated includes a medication risk score.

12. The computer readable medium of claim 11, wherein the method further comprises enrolling the user in a lifestyle management program and associating the user with a lifestyle mentor.

13. The computer readable medium of claim 12, wherein the method further comprises:
providing a lifestyle risk assessment questionnaire to the user;
receiving a lifestyle response from the user;
generating a lifestyle alert based on the received response;
updating the risk score associated with the user based on at least one of the lifestyle alert and the lifestyle response provided by the user;
generating a lifestyle report based on at least one of the lifestyle alert, the alert and the risk score associated with the user;
notifying a lifestyle mentor that at least one of the lifestyle alert and the lifestyle report has been generated upon the generation of the at least one of the lifestyle alert and the lifestyle report;
generating a lifestyle notification associated with a lifestyle mentoring program after the at least one of the lifestyle alert and lifestyle report has been viewed by the lifestyle mentor;
sending the lifestyle notification to at least one of the health care practitioner and the user; and
accepting at least one lifestyle notification response from at least one of the health care practitioner and the user, based on their review of the lifestyle notification.

14. The computer readable medium of claim 13, wherein the lifestyle mentoring program is at least one of a weight loss program, a stress management program, a nutrition program, an exercise training program, a diabetes management program, and a smoking or tobacco cessation program.

15. The computer readable medium of claim 13, wherein the method further comprises documenting notifications and responses in a log file, the log file accessible by the user, the health care practitioner and the lifestyle mentor.

16. The computer readable medium of claim 11, where the alert is at least one of a cardiovascular risk alert, a body mass index alert, a stress risk alert, a hypertension alert, a cholesterol level alert, a diabetic alert, a depression alert, a cancer alert, a high risk pregnancy alert, an asthma alert, a chronic obstructive pulmonary disease alert, and a medication risk alert.

17. The computer readable medium of claim 10, wherein the health risk assessment questionnaire includes questions related to at least one of lifestyle factors, user-risk factors, diseases, behavioral readiness to change, work related productivity, biometrics, and medication related issues.

18. The computer readable medium of claim 10, where in the method further comprises triaging the alerts and prioritizing the alerts provided to the health care practitioner.
